(19) United States
(12) Patent Application Publication
(10) Pub. No.: US 2016/0020449 A1
(43) Pub. Date: Jan. 21, 2016

(54) ELECTRICALLY-POLYMERIZED SURFACE LAYER FOR ARTIFICIAL SOLID-ELECTROLYTE-INTERPHASE (SEI) LAYERS ON SILICON AND CARBON BASED ELECTRODES

(71) Applicant: Wisconsin Alumni Research Foundation, Madison, WI (US)

(72) Inventors: Robert John Hamers, Madison, WI (US); Laura Elizabeth Slaymaker, Madison, WI (US)

(21) Appl. No.: 14/716,410

(22) Filed: May 19, 2015

Related U.S. Application Data
(60) Provisional application No. 62/000,607, filed on May 20, 2014.

(51) Int. Cl. H01M 2/16; C25D 9/02; H01M 4/587; H01M 4/134; H01M 4/38; C07F 7/08; H01M 4/133

(52) U.S. Cl. CPC H01M 2/1673; C07F 7/0849; C25D 9/02; H01M 4/133; H01M 4/134; H01M 4/386; H01M 4/587; H01M 2004/027

(57) ABSTRACT

Provided is an electrode comprising an active material comprising silicon, carbon or both, and a layer comprising active material protecting compounds covalently bound to the surface of the active material, the active material protecting compounds comprising an electrochemically polymerizable group, e.g., an aryl group or a cyclic alkenyl group. Batteries incorporating the electrodes are also provided, e.g. lithium ion batteries.

### CROSS-REFERENCE TO RELATED APPLICATION

The present application claims priority to U.S. Provisional Patent Application No. 62/000,607 that was filed May 20, 2014, the entire contents of which is hereby incorporated by reference.

### BACKGROUND

There is great interest in the use of silicon-based anodes for high-energy lithium ion batteries. Compared with graphite anodes, silicon can hold approximately 10 times as much lithium per unit weight. A major aim is to link the high capacity of silicon with a high-voltage cathode. A key aspect of lithium ion battery operation is the formation of a solid-electrolyte interphase (“SEI”) layer on the anode surface. The SEI layer acts as a very thin, protective layer on the anode surface that prevents direct contact of the electrolyte solution with the anode surface, further decomposition of the electrolyte solution and maintains stable cycling performance. In conventional lithium ion batteries, the SEI layer is typically achieved through additives, such as vinyl carbonate or fluorinated ethylene carbonate, that are added to the electrolyte solution and that decompose to form the SEI layer upon the first charge of the battery.

However, a major impediment to the use of silicon anodes is that mechanical expansion of the silicon upon lithium intercalation leads to fracturing of the SEI layer, which ultimately results in continual SEI layer formation over multiple cycles rather than forming on the first charge cycle and then stopping. A damaged SEI layer allows electrolyte solution to gradually contact the anode surface, leading to decomposition of the electrolyte solution, disintegration of the anode and poor cycling performance. In addition, additives typically used to achieve well-performing SEI layers, such as vinyl carbonate, are reactive toward emerging high-voltage cathode materials.

### SUMMARY

Provided herein are electrodes and batteries incorporating the electrodes, including lithium ion batteries.

In one aspect, an electrode is provided comprising an active material comprising silicon, carbon or both, and a layer comprising active material protecting compounds covalently bound to the surface of the active material, the active material protecting compounds comprising an electrochemically polymerizable group selected from aryl groups and cyclic alkenyl groups.

In another aspect, a lithium ion battery is provided comprising an anode electrode comprising an active material comprising silicon, carbon or both, and a layer comprising active material protecting compounds covalently bound to the surface of the active material, the active material protecting compounds comprising an electrochemically polymerizable group selected from aryl groups and cyclic alkenyl groups; a cathode electrode; a separator between the anode electrode and the cathode electrode; and an electrolyte solution diffused throughout the separator.

In another aspect, a method of forming a solid electrolyte interphase layer is provided comprising applying a potential to an electrode comprising an active material comprising silicon, carbon or both, and a layer comprising active material protecting compounds covalently bound to the surface of the active material, the active material protecting compounds comprising an electrochemically polymerizable group selected from aryl groups and cyclic alkenyl groups, wherein the applied potential is sufficient to reduce the electrochemically polymerizable group and initiate polymerization reactions between the electrochemically polymerized groups of neighboring active material protecting compounds to form the solid electrolyte interphase layer.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 shows a schematic depiction of surface grafting of the active material protecting compound precursor, 1-naphthyltriethoxysilane, on the surface of a silicon nanoparticle, followed by electrochemical reduction and polymerization to form an artificial SEI layer (a layer of covalently bound, electrochemically polymerized active material protecting compounds) on the surface.

FIG. 2 shows a cyclic voltammogram of the active material protecting compound precursor, 1-naphthyltriethoxysilane.

FIG. 3 shows a cyclic voltammogram of active material protecting compound precursor, 9-phenanthrenyltriethoxysilane.

FIG. 4 shows a cyclic voltammogram of a blank electrolyte solution with no active material protecting compound precursor.

FIG. 5 shows the infrared spectra of the active material protecting compound precursor, 1-naphthyltriethoxysilane (A), the surface of silicon after functionalization with the precursor (B) and the surface of an unfunctionalized silicon sample (C).

FIG. 6 shows the Coulombic Efficiency measurements of unfunctionalized silicon anodes (squares) and silicon anodes functionalized with 1-naphthyltriethoxysilane (circles) in half-cells with an electrolyte solution including F1S3M2 and 1 M LiPF₆.

FIG. 7 shows the Coulombic Efficiency measurements of unfunctionalized silicon anodes (squares) and silicon anodes functionalized with 1-naphthyltriethoxysilane (circles) in half-cells with an electrolyte solution including EC:DEC and 1 M LiPF₆.

FIG. 8 illustrates a schematic of a lithium ion battery according to an illustrative embodiment.

### DETAILED DESCRIPTION

Provided herein are electrodes and batteries incorporating the electrodes, including lithium ion batteries.

In one aspect, an electrode is provided comprising an active material comprising silicon, carbon or both, and a layer comprising active material protecting compounds covalently bound to the surface of the active material, the active material protecting compounds comprising an electrochemically polymerizable group.

The active material comprises silicon, carbon or both. The active material may consist of, or consist essentially of, silicon. The active material may consist of, or consist essentially of, carbon. The active material may be formed from silicon-containing composites or alloys or carbon-containing composites or alloys. The active material may be formed from silicon-carbon composites. However, in some embodiments, the active material is substantially free of carbon. The form of the active material is not limited. Suitable forms include particles in the shape of spheres, fibers, rods, tubes, needles, whiskers, etc. The particles may be nanoparticles having one, two or three dimensions which are less than about 1000 nm. Other exemplary forms for carbon active material include graphene and graphite.

The active material is functionalized with active material protecting compounds covalently bound to the surface of the active material. An active material protecting compound is bound via one or more (e.g., two or three) covalent linkages derived from one or more surface linking groups of an active material protecting compound precursor. In other words, the one or more surface linking groups of an active material protecting compound precursor react with the surface of the active material to provide the active material protecting compound covalently bound to the surface via one or more covalent linkages.

A variety of surface linking groups may be used to generate the covalent linkages, provided the surface linking group is capable of forming a covalent bond to silicon, carbon, or both. An exemplary surface linking group is an alkoxy group, RO—, wherein “—” denotes the covalent linkage to the active material protecting compound precursor and R is a linear, branched or cyclic alkyl group in which the number of carbons may range from, e.g., 2 to 24, 2 to 12, 2 to 6, etc. The alkyl group may be unsubstituted, by which it is meant the alkyl group contains no heteroatoms. The alkyl group may be substituted, by which it is meant an unsubstituted alkyl group in which one or more bonds to a carbon(s) or hydrogen(s) are replaced by a bond to non-hydrogen and non-carbon atoms. Non-hydrogen and non-carbon atoms include, e.g., a halogen atom such as F, Cl, Br, and I; an oxygen atom in groups such as hydroxyl, alkoxy, aryloxy, carbonyl, carboxyl, and ester groups; and a nitrogen atom in groups such as amines, amides, alkylamines, arylamines, and alkylarylamines, and nitriles. Alkoxy surface linking groups may be covalently bound to silicon and carbon using known techniques, e.g., as described in Example 2, below.

Another exemplary surface linking group is a carbon-carbon double bond in a mono- or polyunsaturated, linear, branched or cyclic alkenyl group in which the number of carbons may range from, e.g., 2 to 24, 2 to 12, 2 to 6, etc. The alkenyl group may be unsubstituted or substituted as described above with respect to alkyl groups. In some embodiments, the carbon-carbon double bond is at or near a terminal carbon of the alkenyl group. In some embodiments, the surface linking group is a vinyl group, H₂C═CH—, wherein “—” denotes the covalent linkage to the active material protecting compound precursor. Such surface linking groups may be covalently bound to silicon and carbon using the techniques described in U.S. Pat. No. 6,569,979, which is herein incorporated by reference.

Another exemplary surface linking group is a thiol group, HS—, wherein “—” denotes the covalent linkage to the active material protecting compound precursor. Such surface linking groups may be covalently bound to silicon and carbon using known techniques.

In some embodiments, the surface linking group is not a carboxyl group, a diene group or a dienophile group.

The amount of active material protecting compounds covalently bound to the surface of the active material is desirably that which prevents or substantially prevents the electrolyte solution from contacting the surface of the active material. A sufficient amount of active material protecting compounds may be covalently bound to provide a monolayer of active material protecting compounds on the surface of the active material. However, smaller amounts of active material protecting compounds may be used.

The active material protecting compounds (and the active material protecting compound precursors) comprise an electrochemically polymerizable group. The electrochemically polymerizable group may be situated anywhere within the active material protecting compound, but the group is desirably situated at a terminal position. The electrochemically polymerizable group is capable of being reduced by the application of a potential to form an anionic species. The anionic species may be singly-charged or multiply-charged, e.g., 2⁻, 3⁻, etc. Upon electrochemical reduction, the electrochemically polymerizable group undergoes one or more polymerization reactions to covalently crosslink the electrochemically polymerizable group to one or more electrochemically polymerizable groups on one or more other active material protecting compounds, i.e., neighboring active material protecting compounds. For example, upon electrochemical reduction, the anionic species of a first electrochemically polymerizable group on a first active material protecting compound reacts with the anionic species of a second electrochemically polymerizable group on a second active material protecting compound to form a covalent crosslink between the first electrochemically polymerizable group and the second electrochemically polymerizable group. If the anionic species of the first electrochemically polymerizable group is multiply-charged, it may be able to form more than one covalent crosslink, e.g., another covalent crosslink to the second electrochemically polymerizable group and/or a covalent crosslink to a third electrochemically polymerizable group on a third active material protecting compound.

By using the disclosed active material protecting compounds, no separate crosslinking molecules are necessary to form the covalent crosslinks between different electrochemically polymerizable groups. Rather, the covalent crosslinks are chemical bonds between atom(s) of one electrochemically polymerizable group and atom(s) of another electrochemically polymerizable group. The polymerization reactions between the electrochemically polymerizable groups of different active material protecting compounds facilitate the formation of an interlinked network of active material protecting compounds, i.e., a polymeric layer, covalently bound to the surface of the active material. The number of crosslinks and extent of polymerization is desirably that which prevents or substantially prevents the electrolyte solution from contacting the surface of the active material.

The electrochemically polymerizable group is desirably characterized by a reduction potential which is more positive than the lithium reduction potential, which is about −3.0 V vs. the Standard Hydrogen Electrode (SHE). Such electrochemically polymerizable groups will polymerize before substantial intercalation of lithium into the active material. In some embodiments, the electrochemically polymerizable group is characterized by a reduction potential in the range of from about −2.5 V to about 0.5V vs. SHE or from about −2.0 V to about 0.5 V vs. SHE.

The electrochemically polymerizable group is desirably capable of forming a multiply charged anionic species upon electrochemical reduction so as to enable multiple covalent crosslinks. Such electrochemically polymerizable groups will facilitate the formation of an interlinked network of active material protecting compounds. In some embodiments, the electrochemically polymerizable group is capable of forming at least two, at least three or at least four covalent crosslinks.

The electrochemically polymerizable group is desirably hydrophobic. Such electrochemically polymerizable groups will repel the electrolyte solution, thereby preventing or substantially preventing the electrolyte solution from contacting the surface of the active material. The hydrophobicity of the electrochemically polymerizable groups may be characterized by the solubility of the groups in water. In some embodiments, the electrochemically polymerizable groups are characterized by a solubility of no more than about 50 mg/L in water. This includes embodiments in which the electrochemically polymerizable groups are characterized by a solubility of no more than about 30 mg/L, no more than about 15 mg/L, no more than about 5 mg/L, or no more than about 1 mg/L in water. In some embodiments, the electrochemically polymerizable groups are substantially insoluble in water. In some embodiments, the electrochemically polymerizable groups are substantially insoluble in an electrolyte solution, including any of the electrolyte solutions described herein.

The electrochemically polymerizable group is desirably characterized by a molecular size that is sufficiently large compared to the size of the footprint of the active material protecting compound formed by the covalent linkages to the surface of the active material so as to enable the electrochemically polymerizable groups of neighboring active material protecting compounds to get sufficiently near to one another to undergo the polymerization reactions described above. In some embodiments, the molecular size of the electrochemically polymerizable group is as large as or larger than the size of the footprint of the active material protecting compound.

A variety of electrochemically polymerizable groups may be used, including groups having one or more or all of the desirable characteristics described above. Typically, the electrochemically polymerizable group is different from the one or more surface linking groups on the active material protecting compound precursor. In some embodiments, the electrochemically polymerizable group is an aryl group. The aryl group may be monocyclic having one aromatic ring or polycyclic having fused aromatic rings (e.g., two, three, etc. rings). Monocyclic aryl groups may be unsubstituted or substituted as described above with respect to alkyl groups. However, substituted monocyclic aryl groups also refer to an unsubstituted monocyclic aryl group in which one or more carbon atoms are bonded to an unsubstituted or substituted alkane, an unsubstituted or substituted alkene, or an unsubstituted or substituted monocyclic aryl group or a polycyclic aryl group. The meaning of unsubstituted and substituted alkanes and unsubstituted and substituted alkenes follows the meaning described above for unsubstituted and substituted alkyl and alkenyl groups, respectively. Polycyclic aryl groups are unsubstituted. Exemplary substituted monocyclic aryl groups include styrene and aniline. Exemplary polycyclic aryl groups include naphthalene, anthracene and phenanthrene.

In some embodiments, the electrochemically polymerizable group is a mono- or polyunsaturated cyclic alkenyl group in which the number of carbons may range from, e.g., 5 to 24, 5 to 12, 5 to 8, etc. Cyclic alkenyl groups are non-aromatic. The cyclic alkenyl group may be unsubstituted or substituted as described above with respect to alkenyl groups.

In some embodiments, the electrochemically polymerizable group is not a vinyl group, an ethoxy group, furan, or cyclopentadiene.

A variety of active material protecting compound precursors having any of the surface linking groups and electrochemically polymerizable groups described above may be used to functionalize the surface of an active material. Silanes, phosphonates, phosphonic acids and alkenes are exemplary active material protecting compound precursors. In some embodiments, the active material protecting compound precursor is a silane comprising one, two or three alkoxy groups and an electrochemically polymerizable group. In some embodiments, the active material protecting compound precursor has Formula 1

R₁SiR₂R₃R₄ Formula 1

wherein R₁ is selected from electrochemically polymerizable groups and at least one of R₂, R₃, and R₄ is an alkoxy group and the remaining groups are independently selected from hydrogen, hydroxyl group and alkoxy groups. In some such embodiments, R₂, R₃ and R₄ are independently selected from alkoxy groups. The alkoxy groups on the silane may be the same or different. Any of the disclosed alkoxy groups and electrochemically polymerizable groups may be used. Examples of silane active material protecting compound precursors include 1-naphthyltriethoxysilane and 9-phenanthrenyltriethoxysilane.

In some embodiments, the active material protecting compound precursor is a phosphonate or a phosphonic acid comprising one or two alkoxy groups and an electrochemically polymerizable group. In some embodiments, the active material protecting compound precursor has Formula 2

R₁PO(OR₂)(OR₃) Formula 2

wherein R₁ is selected from electrochemically polymerizable groups and R₂ and R₃ are independently selected from hydrogen, alkyl groups and aryl groups. Any of the disclosed alkoxy groups, alkyl groups, aryl groups and electrochemically polymerizable groups may be used.

In some embodiments, the active material protecting compound precursor is an alkene comprising an electrochemically polymerizable group. The meaning of alkene follows the meaning described above for unsubstituted and substituted alkenyl groups. That is, the alkene may be unsubstituted (other than the electrochemically polymerizable group), substituted (in addition to the electrochemically polymerizable group) and mono- or polyunsaturated. The unsaturation (if monounsaturated) or at least one unsaturation (if polyunsaturated) may be positioned at or near a terminal carbon. In some embodiments, the active material protecting compound precursor has Formula 3

R₁(CH₂)ₙR₂ Formula 3

wherein R₁ is selected from electrochemically polymerizable groups, n is an integer from 2 to 24 and R₂ is a vinyl group.

In some embodiments, the active material protecting compound precursor is not one of the following compounds: tris(2-methoxyethoxy)vinylsilane); a dioxasilaphane compound; 2,2-dimethoxy-1,3,2-dioxasilaphane; 2,2-diethoxy-1,3,2-dioxasilaphane; 3,3,9,9-tetramethoxy-2,4,8,10-tetraoxa-3,9-disilapiro[5.5]undecane; 3,3,9,9-tetraethoxy-2,4,8,10-tetraoxa-3,9-disilapiro[5.5]undecane; 2,2-diethoxy-4,7-dihydro-1,3,2-dioxasilaphane; a maleimide or bismaleimide compound; phenylmethane maleimide; N,N′-diphenylmethane bismaleimide; N-(2-(2-ethoxyethoxy)ethyl)-maleimide; N-(methoxy-polyethylene glycol 550)-maleimide; N,N′-(Jeffamine® D400) bismaleimide; N,N′-(oxybis(4,1-phenylene)) bismaleimide; a furfuryl or bisfurfuryl alcohol compound; O-(methoxy-polyethylene glycol 550)-furfuryl alcohol; O-(polyethylene glycol 200)-bisfurfuryl alcohol; or alginate. Similarly, in some embodiments, the active material protecting compound covalently bound to the surface of the active material is not derived from one of these precursors. In some embodiments, the active material protecting compound precursor is not a siloxane and the active material protecting compound is not derived from a siloxane.

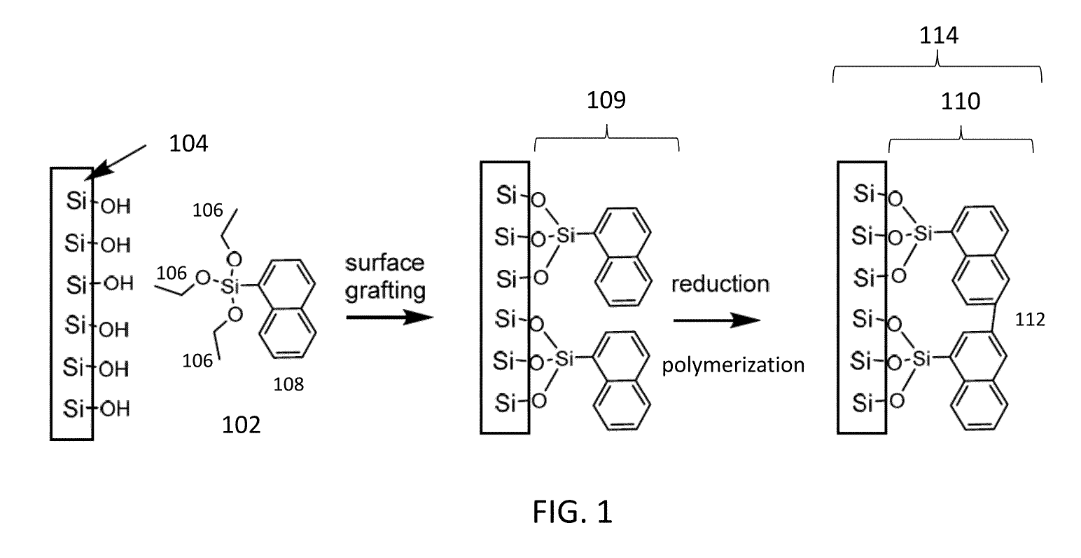

FIG. 1 shows a schematic depiction of surface grafting of the active material protecting compound precursor 102 (1-naphthyltriethoxysilane) on the surface of a silicon nanoparticle 104 to form an electrode 114. The active material protecting compound precursor 102 comprises surface linking groups 106 and an electrochemically polymerizable group 108. Surface grafting provides a layer 109 of active material protecting compounds covalently bound to the surface of the silicon nanoparticle 104 through multiple covalent linkages. Next, electrochemical reduction and polymerization converts the layer 109 to an artificial solid electrolyte interphase layer 110 comprising covalently bound, electrochemically polymerized active material protecting compounds. The polymerization reactions initiated by the electrochemical reduction provide crosslinks 112 between the electrochemically polymerizable groups 108 on neighboring active material protecting compounds.

The functionalized active material may be combined with other components, e.g., as part of an active material composition, typically used to form electrodes, e.g., a binder, a conductivity enhancer and a solvent. A variety of binders (e.g., polyvinylidenefluoride), conductivity enhancers (e.g., carbon black) and solvents may be used. The functionalized active material and other components (if present) may be deposited on a metallic substrate (e.g., copper) to form the electrode. Depending upon the materials used to form the electrode, the electrode may be an anode or a cathode of an electrochemical device, e.g., a battery.

Also provided is the functionalized active material itself, i.e., the active material comprising silicon, carbon or both and a layer comprising active material protecting compounds covalently bound to the surface of the active material, the active material protecting compounds comprising an electrochemically polymerizable group.

In another aspect, a battery is provided comprising an anode electrode, a cathode electrode, a separator between the anode electrode and the cathode electrode and an electrolyte solution diffused throughout the separator. The anode electrode or the cathode electrode may comprise any of the functionalized active materials described above. In some embodiments, the battery is a lithium ion battery comprising an anode electrode comprising any of the functionalized active materials described above, a cathode electrode, a separator between the anode electrode and the cathode electrode and an electrolyte solution diffused throughout the separator. A variety of materials for the cathode electrode may be used, e.g., a lithium containing metal oxide. A variety of materials for the separator may be used, e.g., glass fiber. A variety of electrolyte solutions may be used. For example, the electrolyte solution may comprise an organic electrolyte and a lithium salt. A variety of organic electrolytes may be used, including organosilicon-based electrolyte such as F1S3M2 and carbonate electrolytes. A variety of lithium salts may be used, e.g., LiPF₆. The electrolyte solution is typically substantially free of the active material protecting compound or active material protecting compound precursor as these compounds functionalize the surface of the active material and are not additives in the electrolyte solution. However, the active material protecting compound precursor may also be used as an additive in the electrolyte solution.

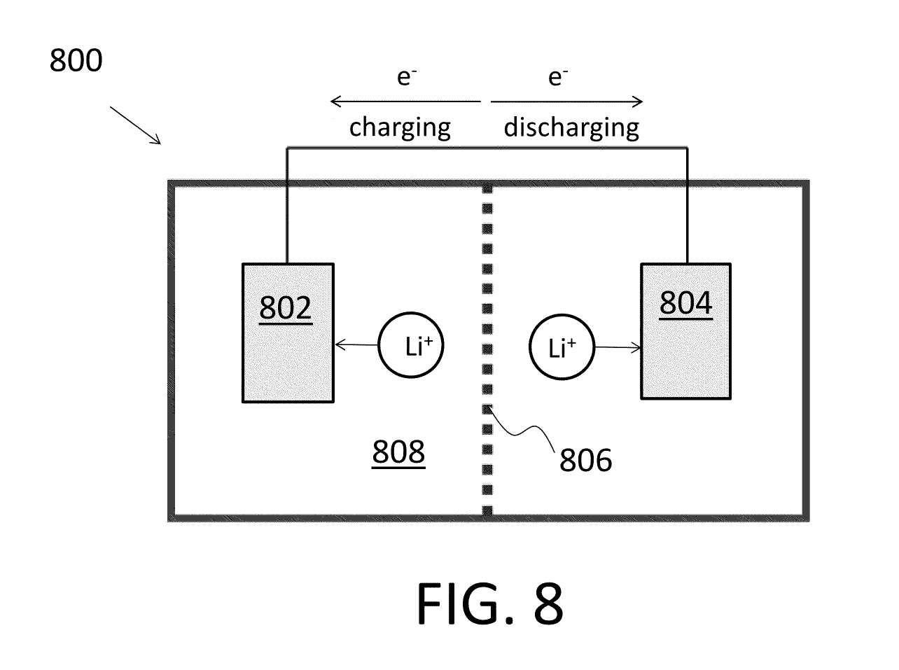

FIG. 8 shows a schematic depiction of a lithium ion battery 800 comprising an anode electrode 802, a cathode electrode 804, a separator 806 between the anode electrode 802 and the cathode electrode 804 and an electrolyte solution 808 diffused throughout the separator. The anode electrode 802 comprises any of the functionalized active materials described above, e.g., as shown in FIG. 1.

Also provided are the disclosed functionalized active materials, electrodes and batteries in which the electrochemically polymerizable groups of active material protecting compounds have polymerized to form a highly crosslinked layer of active material protecting compounds covalently bound to the surface of the active material. In some embodiments, the active material comprises silicon, carbon or both, and a layer comprising active material protecting compounds covalently bound to the surface of the active material, wherein at least some of the active material protecting compounds are crosslinked to neighboring active material protecting compounds via polymerization reactions between the electrochemically polymerizable groups of the neighboring active material protecting compounds. In some embodiments, at least 50% of the active material protecting compounds are crosslinked. In some embodiments, at least 80% of the active material protecting compounds are crosslinked. In some embodiments, substantially all of the active material protecting compounds are crosslinked. As described above, crosslinking provides an interlinked network of active material protecting compounds, i.e., a polymeric layer of active material protecting compounds on the surface of the active material. The polymeric layer is strongly adhered to the surface of the active material through many covalent linkages. The polymeric layer can be tuned to be highly conductive through the selection of electrochemically polymerizable groups and active material protecting compound precursors. As such, the polymeric layer may be distinguished from insulating layers, such as poly(ethylene). In particular, polymeric layers formed from active material protecting groups comprising electrochemically polymerizable groups such as the disclosed aryl groups and cyclic alkenyl groups exhibit substantially more conductivity than poly(ethylene). Similarly, the polymeric layer can be tuned to be highly hydrophobic and mechanically flexible. Each of these properties can greatly improve the efficiency of batteries incorporating the functionalized active materials due to the protection from electrolyte solvent afforded by the polymeric layer.

In another aspect, a method of forming a solid electrolyte interphase layer is provided comprising applying a potential to an electrode comprising an active material comprising silicon, carbon or both, and a layer comprising active material protecting compounds covalently bound to the surface of the active material, the active material protecting compounds comprising an electrochemically polymerizable group, wherein the applied potential is sufficient to reduce the electrochemically polymerizable group and initiate polymerization reactions between the electrochemically polymerized groups of neighboring active material protecting compounds to form the solid electrolyte interphase layer. The applied potential may be that which is sufficient to charge (e.g., initially charge) a battery (e.g., a lithium ion battery) incorporating the electrode. Another method of forming a solid electrolyte interphase layer comprises cycling a battery (e.g., a lithium ion battery) through one or more charge/discharge cycles wherein the layer is formed after completion of the charge/discharge cycle(s). The layer may be substantially formed after the first charge/discharge cycle.

### EXAMPLES

### Example 1

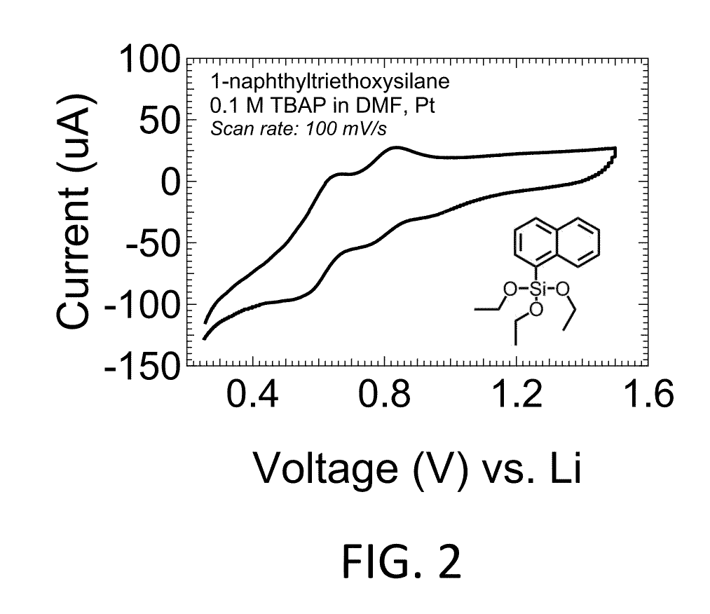

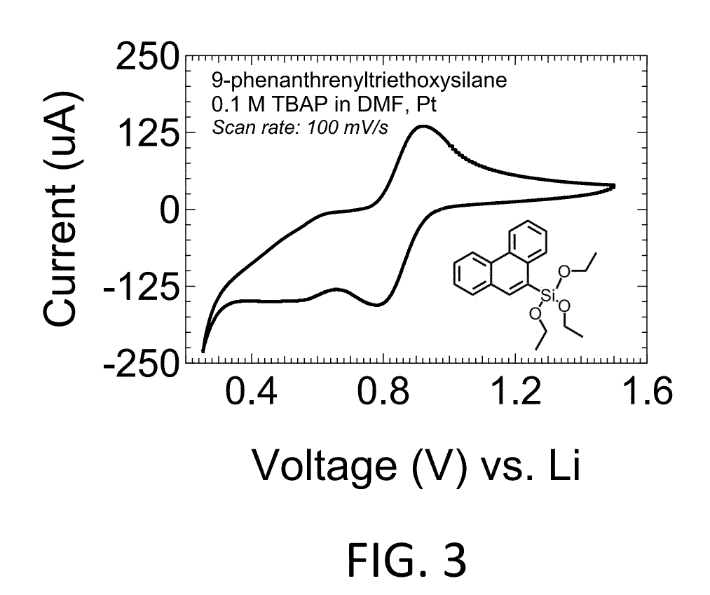

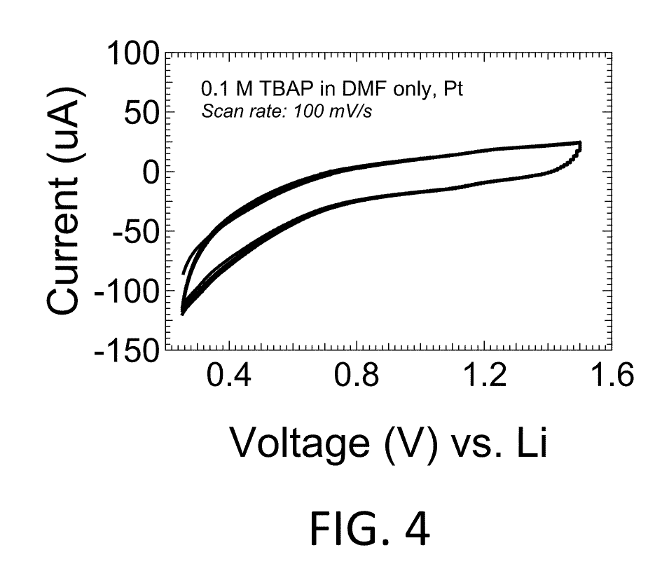

Cyclic voltammograms of active material protecting compound precursors were obtained. Solutions of either 1-naphthyltriethoxysilane or 9-phenanthrenyltriethoxysilane in 0.1 M tetrabutylammonium perchlorate (TBAP) and N,N-dimethylformamide (DMF) were made. Cyclic voltammograms of each solution were obtained, measured at a platinum electrode relative to Li/Li+. The scan rate was 100 mV/s. A cyclic voltammogram of a blank (pure TBAP in DMF) was also obtained. FIG. 2 shows the cyclic voltammogram of the active material protecting compound precursor 1-naphthyltriethoxysilane, FIG. 3 shows the cyclic voltammogram of the active material protecting compound precursor 9-phenanthrenyltriethoxysilane and FIG. 4 shows the cyclic voltammogram of the blank. Comparison of FIGS. 2 and 3 to the blank in FIG. 4 reveals that both of the active material protecting compound precursors exhibit clear reduction features in the potential range of interest, features that arise from the precursors and not from impurities or other components in the electrolyte solution. Thus, the precursors have been shown to form anionic species upon electrochemical reduction. On the short time scale of cyclic voltammetry measurements the reduction features were reversible, as both reduction and subsequent oxidation features were visible. However, when the precursors are held for longer periods of time in close proximity, such as when they are covalently bound to the surface of an active material, the anionic species will undergo one or more of the polymerization reactions described above.

### Example 2

This example shows that covalent grafting of silicon nanoparticles with 1-naphthyltriethoxysilane (active material protecting compound precursor) led to substantial improvement in the efficiency of lithium ion batteries incorporating silicon anodes and the organosilicon-based electrolyte F1S3M2. About 0.4 g of silicon nanoparticles (Alfa Aesar≦50 nm) were placed in about 15 mL H₂O₂ (30% w/v) in a Petri dish and stirred. This mixture was then placed under UV light for 3 hours. After UV treatment, H₂O₂ was removed by heating the mixture on a hot plate at 110° C. for about 20 minutes. Particles were dried overnight under vacuum at 60° C. After drying, the dry nanoparticles were divided into two vials. Both were placed in a glove box (Ar filled) and a small amount (about 1 mL) of dry toluene was added to each. To only one of the vials, 5-10% w/v of 1-naphthyltriethoxysilane (Sigma Aldrich) was added. Both vials were vortexed gently and left overnight in glove box. The following day, the vials containing the functionalized and nonfunctionalized particles were removed from the glove box. Each of these two samples were centrifuged at 3,000 rpm for 15 minutes at 5° C. (to remove toluene and excess silane on the functionalized sample). After centrifugation, the toluene was removed and the particles were left in the centrifuge tube. This process was repeated three times with fresh toluene each time. After this, the particles were dried in a vacuum oven at 40° C. overnight.

The following day, the particles were removed and made into an electrode slurry with 80 wt. % functionalized or non-functionalized silicon nanoparticles, 12 wt. % carbon black (Super P, Tim Cal) and 8 wt. % lithium polyacrylic acid (LiOH, Sigma Aldrich & PAA (250,000 g/mol) Aldrich). A Thinky mixer was used for mixing samples. Each silicon nanoparticle slurry (functionalized and non-functionalized) was cast on copper foil (0.001″ Basic Copper) at 30 μm, using a doctor blade. The electrode films were dried on a film table for about 20 minutes, then moved to a vacuum oven and dried under vacuum for 2.5 hours at 70° C. They were then dried at 90° C. overnight, under vacuum.

The dried films were cut into 15 mm electrodes. Each electrode was pressed at about 3 tons for 1 minute. All pressed electrodes were dried under vacuum (in the vacuum oven in the glove box at room temperature) overnight before use in a coin cell. Coin cell half cells were built using either functionalized or non-functionalized silicon nanoparticle electrodes against lithium. An AP40 glass fiber separator (Millipore) was placed between the electrodes with 500 μL F1S3M2 electrolyte with 1 M LiPF₆. Cells were cycled at about C/10 using an Arbin battery tester. The silicon capacity used to calculate the cell capacity was 1200 mAh/g.

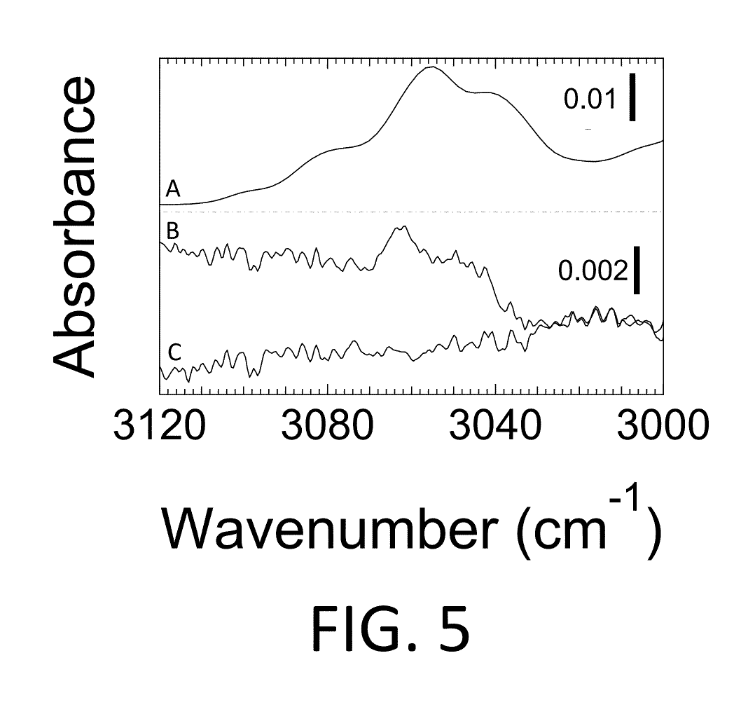

FIG. 5 shows infrared spectra of the active material protecting compound precursor (A) and of the functionalized silicon surface (B), along with a blank (C) silicon sample. The active material protecting compound precursor is presented on a different vertical scale to facilitate comparison. These data show that the functionalized Si sample show two peaks in the 3080-3040 cm⁻¹ region that are characteristic of the C—H compounds of aromatic compounds such as naphthalene. The presence of these features in the functionalized silicon sample confirms successful functionalization of the Si with the 1-naphthylethoxysilane, while their absence in the “blank” sample confirms that these aromatic groups are absent in the non-functionalized Si sample. The relatively weak intensity and signal-to-noise ratio of the spectra shown are typical of monolayer films.

Functionalized and unfunctionalized Si samples exhibiting FTIR spectra like those in FIG. 5 were then incorporated into lithium ion battery half-cells and the Coulombic Efficiency was measured as a function of the cycle number.

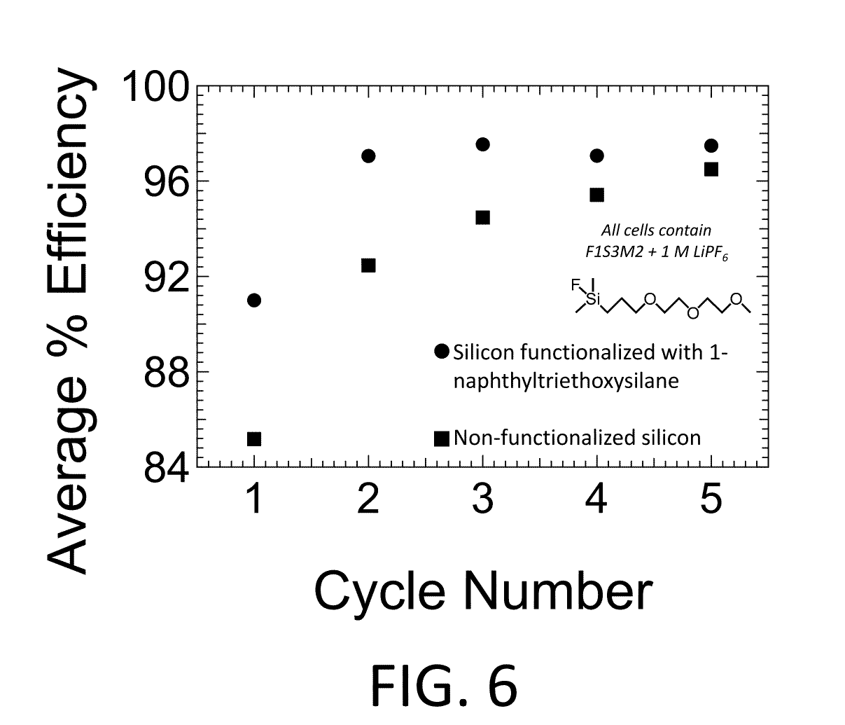

FIG. 6 shows the Coulombic Efficiency (defined as the charge retrieved upon discharge divided by the charge applied during charging) for the first 5 cycles of half-cells using both functionalized and non-functionalized silicon nanoparticle anodes. These data show that the first-cycle efficiency is improved from ˜85% to approximately 91%, with similar (but smaller) improvements in subsequent cycles.

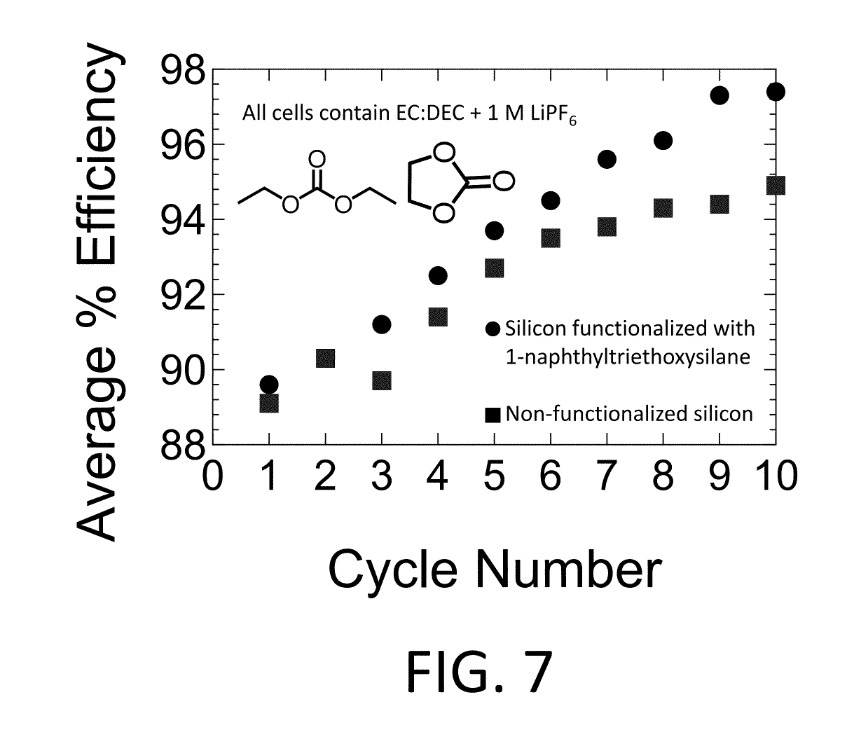

FIG. 7 shows the Coulombic Efficiency for the first 10 cycles of half-cells using both functionalized and non-functionalized silicon nanoparticle anodes. In these half-cells the electrolyte solution included EC:DEC and 1 M LiPF₆. Again, the first-cycle efficiency is improved and additional improvements are achieved in subsequent cycles.

These data demonstrate that silicon anodes functionalized with a layer of active material protecting compounds reduces the irreversible loss, which is primarily associated with a reduction in the amount of SEI layer formed, and leads to significant improvement in cycling efficiency. An improvement in efficiency is a highly desirable property of any battery system.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An electrode comprising an active material comprising silicon, carbon or both, and a layer comprising active material protecting compounds covalently bound to the surface of the active material, the active material protecting compounds comprising an electrochemically polymerizable group selected from aryl groups and cyclic alkenyl groups.

2. The electrode of claim 1, wherein the active material is substantially free of carbon.

3. The electrode of claim 1, wherein the active material protecting compound is bound via one or more covalent linkages derived from one or more surface linking groups of an active material protecting compound precursor, the surface linking groups selected from alkoxy groups, alkenyl groups and thiol groups.

4. The electrode of claim 1, wherein the electrochemically polymerizable group is characterized by a reduction potential which is more positive than the lithium reduction potential.

5. The electrode of claim 4, wherein the reduction potential is in the range of from about −2.5 V to about 0.5 V vs. SHE.

6. The electrode of claim 1, wherein the electrochemically polymerizable group is capable of forming three or more covalent crosslinks to an electrochemically polymerizable group of a neighboring active material protecting compound.

7. The electrode of claim 1, wherein the electrochemically polymerizable group is a substituted monocyclic aryl group.

8. The electrode of claim 7, wherein the substituted monocyclic aryl group is styrene or aniline.

9. The electrode of claim 1, wherein the electrochemically polymerizable group is a polycyclic aryl group.

10. The electrode of claim 9, wherein the polycyclic aryl group is naphthalene, anthracene or phenanthrene.

11. The electrode of claim 1, wherein the active material protecting compound is derived from an active material protecting compound precursor selected from a silane, a phosphonate, a phosphonic acid and an alkene.

12. The electrode of claim 11, wherein the active material protecting compound precursor is a silane comprising one, two or three alkoxy groups and the electrochemically polymerizable group.

13. The electrode of claim 12, wherein the silane has Formula 1
R₁SiR₂R₃R₄ Formula 1
wherein R₁ is the electrochemically polymerizable group and at least one of R₂, R₃, and R₄ is an alkoxy group and the remaining groups are independently selected from hydrogen, hydroxyl group and alkoxy groups.

14. The electrode of claim 11, wherein the active material protecting compound precursor is a phosphonate or a phosphonic acid comprising one or two alkoxy groups and the electro chemically polymerizable group.

15. The electrode of claim 11, wherein the active material protecting compound precursor is a phosphonate or a phosphonic acid having Formula 2
R₁PO(OR₂)(OR₃) Formula 2
wherein R₁ is the electrochemically polymerizable group and R₂ and R₃ are independently selected from hydrogen, alkyl groups and aryl groups.

16. The electrode of claim 11, wherein the active material protecting compound precursor is an alkene having Formula 3
R₁(CH₂)ₙR₂ Formula 3
wherein R₁ is the electrochemically polymerizable group, n is an integer from 2 to 24 and R₂ is a vinyl group.

17. The electrode of claim 11, wherein the active material protecting compound precursor is a silane selected from 1-naphthyltriethoxysilane and 9-phenanthrenyltriethoxysilane.

18. The electrode of claim 1, wherein the active material consists essentially of silicon nanoparticles and the active material protecting compound is derived from an active material protecting compound precursor selected from 1-naphthyltriethoxysilane and 9-phenanthrenyltriethoxysilane.

19. A lithium ion battery comprising:
(a) an anode electrode comprising an active material comprising silicon, carbon or both, and a layer comprising active material protecting compounds covalently bound to the surface of the active material, the active material protecting compounds comprising an electrochemically polymerizable group selected from aryl groups and cyclic alkenyl groups;
(b) a cathode electrode;
(c) a separator between the anode electrode and the cathode electrode; and
(d) an electrolyte solution diffused throughout the separator.

20. A method of forming a solid electrolyte interphase layer comprising applying a potential to an electrode comprising an active material comprising silicon, carbon or both, and a layer comprising active material protecting compounds covalently bound to the surface of the active material, the active material protecting compounds comprising an electrochemically polymerizable group selected from aryl groups and cyclic alkenyl groups, wherein the applied potential is sufficient to reduce the electrochemically polymerizable group and initiate polymerization reactions between the electrochemically polymerized groups of neighboring active material protecting compounds to form the solid electrolyte interphase layer.
